(19) United States
(12) Patent Application Publication
(10) Pub. No.: US 2007/0209710 A1
(43) Pub. Date: Sep. 13, 2007

(54) Valve used for vapor-tightly disconnecting two interconnected process units

(75) Inventors: Lutz GOTTSMANN, Kleinroehrsdorf (DE); Ulf SEYFERT, Dresden (DE); Bernd-Dieter WENZEL, Grossharthau-Buehlau (DE); Reinhard JAEGER, Coswig (DE)

Correspondence Address: HESLIN ROTHENBERG FARLEY & MESITI PC, 5 COLUMBIA CIRCLE, ALBANY, NY, 12203, US

(73) Assignee: VON ARDENNE Anlagentechnik GmbH, Dresden (DE)

(21) Appl. No.: 11/568,333

(22) PCT Filed: Apr. 16, 2005
(86) PCT No.: PCT/DE05/00701

§ 371 Date: Feb. 23, 2007

(30) Foreign Application Priority Data
Apr. 27, 2004 (DE) 10 2004 020 844.1
Aug. 27, 2004 (DE) 10 2004 041 853.5

(51) Int. Cl. F16K 49/00; F16K 31/00

(52) U.S. Cl. 137/341; 251/335.3; 251/61.4

(57) ABSTRACT

A valve is used for vapor-tightly disconnecting two interconnected process units. The valve comprises a continuous duct which connects two vacuum evaporators that are individually provided with an outer vapor-proof jacket, and a blocking mechanism mounted in the duct. In order to allow the two interconnected vacuum evacuators to be disconnected in a vapor-proof manner such that the functional reliability is improved, a vapor-impinged surface of the valve duct is provided with a vapor condensation-repellent zone which is connected in a thermally conducting manner to a heating apparatus that envelopes the valve.

The invention relates to a valve for vapor-tightly disconnecting two interconnected process units using a continuous duct which connects the two process units and a blocking mechanism mounted in the duct.

Valves for blocking gases, liquids and bulk products are extant. They are typically used in chemical or vacuum construction.

A disadvantage of the valves known from the prior art lies therein that their functionality and reliability cannot be guaranteed upon impingement with hot, vapor-like coating material, in particular in vacuum systems for coating substrates with metallic materials by means of physical vapor deposition (PVD).

The causes can, on the one hand, be seen from the fact that the vapor-like coating material flows through precipitate on the duct wall of the valve. The coating material must be conveyed through the valve in the form of hot vapor with an open valve position or must keep hot vapor away from the process space of the side feeding the coating material with a closed valve position. At the same time, condensation deposits occur on the components of the valve which are colder in relation to the process temperature. A continuously developing layer structure results in a functional restriction or functional disturbance of the opening and, in particular, closing function of the valve, as the intended functional tolerances for realizing movements, and the fitting forms adapted to one another for sealing are affected.

On the other hand, unwanted alloy formations occur between the vapor-like metallic coating material and the valve itself in the case of valves corresponding to the prior art, which results in irreversible damage to the valve. Both effects affect the functional capability of the entire vacuum system.

It is therefore the task of the present invention to provide a valve that allows two interconnected vacuum process chambers to be disconnected in a vapor-proof manner such that the functional reliability is improved.

Corresponding to the invention, the task is solved by virtue of the fact that the vapor-impinged surface of the valve duct exhibits a vapor condensation-repellent zone, which is connected in a thermally conducting manner to a heating apparatus that is embodied so as to envelope the valve.

Owing to a sufficiently high temperature on the duct walls, the vapor-like coating material occurring thereon is re-vaporized and hence reflected into the duct. The higher the temperature, the greater this effect. With increasing temperature on the surface, the deposition quantity of the vapor-like coating material flowing through reduces as far as a transport essentially free of condensation deposits at temperatures above the vaporization temperature of the relevant coating material in relation to the pressure.

For temperature and pressure resistance of the valve at utilization temperatures in a range from 20° C. to 1,000° C., preferably in a range from 20° C. to 800° C., the valve body is essentially produced from a material with a correspondingly high thermal stability. Likewise, all other components located in the duct essentially consist of materials with a correspondingly high or higher thermal stability. All components, also those not located in the area of the duct or on the duct surface, are adapted to one another in their material selection in respect to strength, in particular strength at high and higher temperatures, longitudinal elongation coefficients and resistance against the vapor of the coating material.

The said aim is achieved if the blocking device is connected in a thermally conducting manner via the heating apparatus to the entire area of the duct surface, additionally to the vapor-impinged surface of the duct.

In this way, the condensation of the vapor-like coating material is prevented across the entire course of the valve. For this purpose, a radiant heating device, which is preferably realized as an electrical resistance heating device, is mounted as a heating apparatus around the valve body.

In order to reduce a temperature influence of the process space of the evaporation (first vacuum process chamber) through the process space of the vaporization (second vacuum process chamber) at temperature differences between the two with a closed valve position, it is advantageous if at least one partial section of the duct of the valve exhibits a direction of the duct course different from the other partial sections of the duct in contrast to the remaining partial sections of the duct.

Alternatively or additionally to this, it is envisaged in a further embodiment for reduction of a temperature influence on one vacuum process chamber by the other vacuum process chambers at temperature differences between these with a closed valve position, that the two duct openings on the relevant side of the valve are located aligned to one another height-adjusted and/or side-adjusted.

It is advantageous if the duct heating apparatus exhibits at least two heating parts independent of one another, whereby one relevant heating part is located in the area of one of the two duct sections extending from the blocking device. In this way, temperature regimes adjusted to the relevant process conditions can be created on the vapor inlet and vapor outlet side, that is to say on the vaporization and evaporation side.

In one embodiment it is envisaged that the blocking device comprises a seal, whereby the seal is located on a circumferential protrusion in the duct surface.

The seal is preferably designed as a circumferential flat seal and lies on the circumferential protrusion in the duct surface. Other suitable embodiments of the seal are also recorded by the invention, such as a fibrous seal. However, the seal always exhibits at least the same thermal stress resistance as the duct surface.

In a preferred further design, it is envisaged that the blocking device comprises a tappet with a valve disk on the end side.

The tappet is located at an angle, preferably somewhat transverse, to the direction of flow of the duct. The valve disk located on the end side of the tappet is borne so as to have linear movement in the area of a duct bend in the duct by means of a tappet bearing. The tappet bearing comprises at least one, preferably two or more staggered, seals located circumferentially around the tappet for a vacuum-tight design of the valve.

In the case of an open valve position, the valve disk releases the duct bend and is located in a spatial recess in the duct bend. In the case of a closed valve position, the valve disk is located on the protrusion formed parallel to the valve disk in the duct or on the seal on the protrusion. The duct opening area is therefore closeable regarding the full circumference in terms of the function of a disk valve.

In a particularly preferred further embodiment, it is envisaged that the tappet and/or the valve disk exhibits an inner space. It is most particularly preferable if a heating apparatus is located in the inner space. On account of the heating apparatus which heats additionally to the heat radiation, complete heating right into the subsidiary chambers of the duct is ensured.

The invention will be explained below on the basis of an embodiment example. In the associated drawings:

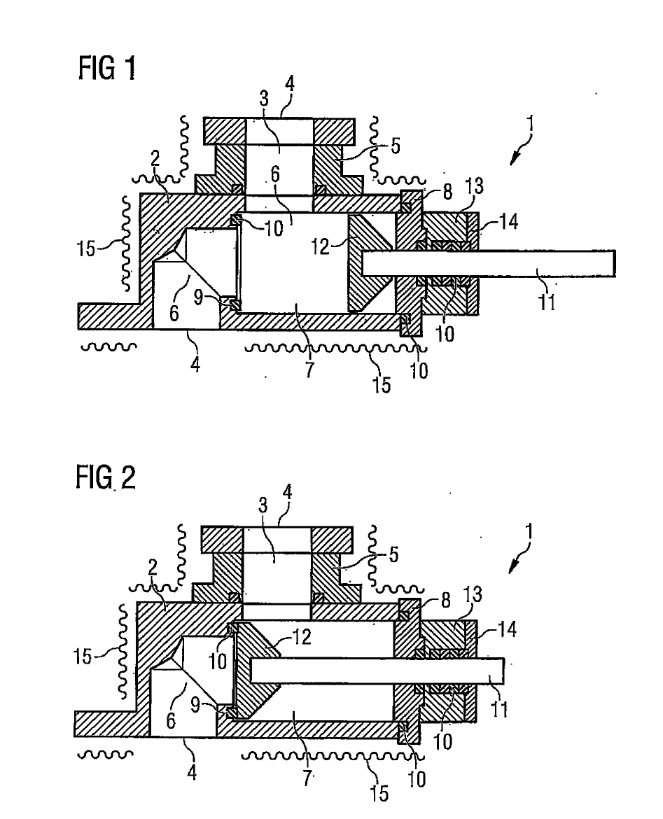

FIG. 1 shows a cross section through a valve corresponding to the invention in an open state and

FIG. 2 shows a cross section through a valve corresponding to the invention in a closed state.

FIGS. 1 and 2 show a valve (1) corresponding to the invention with a duct (3) passing through the valve housing (2) and a blocking device mounted in the duct.

For temperature and pressure resistance of the valve with the process temperatures usual for the vacuum coating, the valve body is essentially produced from graphite or another material with a correspondingly high thermal stability. In the same way, all further components located in the duct (4) essentially consist of the same or comparable thermally stable material. For further components not located in the duct (4) or on the duct surface, other thermally stable materials can be used, for example high-temperature-stable steel or a similar steel alloy.

A flange is mounted on a first duct opening (4) for assembly purposes. The duct course essentially exhibits an initial bend (6) of 90° and a second bend (6) of 90° starting out from the opening provided with a flange (5), so that the two duct ends are aligned parallel, i.e. not linear, on the duct openings (4). The duct (3) is formed tube-like and round in the area of the duct openings (4) and the second bend (6). In the first bend (6), a circumferential, in the embodiment example ring-shaped, protrusion is incorporated in the duct (3), whereby a recess for supporting a seal (10) is formed in the protrusion (9). The external diameter of the protrusion (9) corresponds to the diameter of the cylindrical recess for the disk valve (8) in the first bend (6).

The disk valve (8) consists of a tappet (11) and a valve disk (12) mounted on the end of the tappet (11). The tappet (11) protrudes out of the valve housing (2) transversely to the two end-side duct sections. A recess (7) with a seal (10) is incorporated in the passage area circumferentially around the tappet outlet externally on the valve housing (2). In addition to this, a sealing body (13) with several seals (10) arranged staggered is mounted in the outlet area of the tappet (11). The tappet (11) also protrudes out of the sealing body (13), also when the valve (1) is closed, and is connected on the end side to a valve train (not shown here).

FIG. 1 shows the valve when opened. The valve disk diameter is smaller than the recess diameter, with the result that a pressure difference between the two sides of the valve disk (12) is reduced in the case of a disk valve movement due to a through-flow around the valve disk (12). The disk valve (8) is located in the cylindrical recess (7) in the first bend (6) when in the opened position and hence releases the duct (3) for the through-flow.

FIG. 2 shows the valve (1) when closed. The valve disk (12) is located on the seal (10) in the protrusion (9) formed parallel to the valve disk (12) in the duct (3). The duct passage is circumferentially sealed in terms of the function of a disk valve (8).

The valve housing (2) is designed in two parts for disassembly of the disk valve (8), so that the housing wall in the area of the penetration of the tappet (11) through the valve housing (2) is formed as a housing cover (14) and loosened from the remaining valve housing (14) and can be fixed again on this vacuum-tightly with a seal (10). The housing cover diameter is, at the same time, larger than the valve disk diameter. The sealing body (13) is therefore mounted on the housing cover (14).

The heating apparatus (15) is mounted as a radiant heating device in the form of an electrical resistance heating device around the valve housing (2) with add-on parts. The valve housing (2) can be heated up to around 1,000° C. by means of the heating apparatus. At the same time, the disk valve (8) is heated to the same temperature as the duct wall via the good thermal conductivity of the material and through heat radiation. In this way, the duct surface and all the surfaces located in the duct (3) can essentially be temperature controlled homogenously by means of the heating apparatus (15).

### Valve Used for Vapor-Tightly Disconnecting Two Interconnected Process Units

### REFERENCE SIGN LIST

1 Valve

2 Valve housing

3 Duct

4 Duct opening

5 Flange

6 Duct bend

7 Recess

8 Disk valve

9 Protrusion

10 Seal

11 Tappet

12 Valve disk

13 Sealing body

14 Housing cover

15 Heating apparatus

1. Valve for vapor-tightly disconnecting two interconnected process units using a continuous duct which connects the two process units and a blocking mechanism mounted in the duct, wherein a vapor-impinged surface of the duct exhibits a vapor condensation-repellent zone, said zone being connected in a thermally conducting manner to a heating apparatus that envelopes the valve.

2. Valve according to claim 1, wherein the blocking mechanism is connected in a thermally conducting manner via the heating apparatus to entire area of the duct surface, additionally to the vapor-impinged surface of the duct.

3. Valve according to claim 1, wherein at least one partial section of the duct exhibits a direction of duct course different from other partial sections of the duct in contrast to the remaining partial sections of the duct.

4. Valve according to claim 1, wherein two duct openings on a relevant side of the valve are located aligned to one another height-adjusted and/or side-adjusted.

5. Valve according to claim 1, wherein the heating apparatus exhibits at least two heating parts independent of one another, and one relevant heating part is located in an area of one of two duct sections extending from the blocking mechanism.

6. Valve according to claim 1, wherein the blocking mechanism comprises a seal, and the seal is located on a circumferential protrusion in a surface of the duct.

7. Valve according to claim 1, wherein the blocking mechanism comprises a tappet with a valve disk on an end side.

8. Valve according to claim 7, wherein the tappet and/or the valve disk exhibits an inner space.

9. Valve according to claim 8, wherein the heating apparatus located in the inner space.

10. Valve according to claim 1, wherein the valve exhibits an electro-pneumatic opening/closing drive.

11. Valve according to claim 1, wherein the duct is essentially formed from carbon or another material containing carbon.

12. Valve according to claim 7, wherein the tappet and/or the valve disk essentially consists of carbon or another material containing carbon.
